(19) United States
(12) Patent Application Publication
(10) Pub. No.: US 2003/0191699 A1
(43) Pub. Date: Oct. 9, 2003

(54) Identification system

(76) Inventors: Jean Deveault, Louiseville (CA); Michel Deveault, Trois-Rivieres (CA)

Correspondence Address: BROUILLETTE KOSIE, 25th Floor, 1100 Rene-Levesque Boulevard West, Montreal, QC, H3B 5C9, CA

(21) Appl. No.: 10/189,739

(22) Filed: Jul. 8, 2002

(30) Foreign Application Priority Data
Apr. 9, 2002 (CA) 2,377,393

(51) Int. Cl. G06F 17/60

(52) U.S. Cl. 705/28

(57) ABSTRACT

The present invention relates to an identification system for items having a plurality of component parts, for example furniture. The system of the present invention allows a customer to select from a plurality of furniture components to order a customized piece of furniture. The system also simplifies the manufacturing and inventory control processes.

### FIELD OF THE INVENTION

The present invention relates to an identification system for items having a plurality of component parts, for example furniture. The system of the present invention allows a customer to select from a plurality of furniture components to order a customized piece of furniture. The system also simplifies the manufacturing and inventory control processes.

### DESCRIPTION OF THE PRIOR ART

The sale of furniture and other goods using catalogues is known and has been in use for a long time. Typical catalogues are static in the sense that, although certain color selections are available, the products offered for sale are pre-determined models, as shown or listed in the catalogue.

In current systems, a catalogue provided to a customer normally contains a list of items, and a product identification number for each item. When ordering, a customer writes down the identification numbers and sends the order to the retailer and/or the retailer transcribes these numbers in on order form which is sent of the distributor or manufacturer. The problem is that typical identification numbers are assigned with no apparent relation to the product that is being sold. Therefore if a customer or retailer has filled out an order form with the product identification numbers listed in the catalogue, and thereafter wishes to make sure that the correct numbers were written down, he or she must look through the catalogue again. This can be quite time consuming and therefore many customers and retailers do not verify their orders with the resulting increased possibility of errors.

Similarly, a meaningful product identification system makes it easier for the manufacturer to order and/or produce the component parts and to follow the manufacturing, inventory, invoicing and delivery processes.

It therefore becomes clear that there is a need for a new system for retail in which orders can easily be verified all along the ordering, manufacturing, storage, invoicing and delivery chain and a greater selection of products made available to consumers.

### STATEMENT OF THE INVENTION

The present invention provides a method of identifying items each having a plurality of component parts, each part having a set of characteristics, each said characteristic being selectable from a plurality of predetermined values, said method comprising the steps of:

a) assigning an identifier to each value of each characteristic of each part,

b) creating a code for each part formed by the juxtaposition of the identifiers of each characteristic of such part,

c) creating a code for each item formed by the juxtaposition of the part codes applicable to such item,

d) providing a catalogue having a listing all of said possible items codes.

Another aspect allows for said items to be pieces of furniture such as a table or a chair.

In yet another aspect said characteristics may comprise one or more of the following : material type, first colour, second colour, coating type and/or finish type.

The present invention also provides a method for producing greater reliability in the selection of item each having a plurality of component parts by selecting for each part, a set of predetermined individual characteristics from a predetermined list of characteristics, a plurality of predetermined values being associated with each characteristic, said method comprising the steps of:

a) assigning an identifier to each said value of each said individual characteristic of each said part,

b) creating a part code by juxtaposition of the identifier of the values of the selected characteristics such that no two part has the same identifier;

c) creating item codes by selecting for each part of said item the desired characteristics using said identifiers, such that when ordering said item, it is possible to verify the item that has been selected is the right one by looking at the item code.

### BRIEF DESCRIPTION OF THE DRAWING

FIG. 1 is a diagram of a catalogue page according to one embodiment of the invention.

FIG. 2 is a diagram of a catalogue page containing a list of possible characteristics according to the embodiment shown in FIG. 1.

FIG. 3 is a diagram of a catalogue page containing a list of item numbers according to the embodiment shown in FIG. 1.

### DETAILED DESCRIPTION OF THE PREFERRED EMBODIMENTS

A first embodiment the present invention may be a system for identifying items such as furniture. In this first embodiment the system, each item of furniture is composed of a predetermined number of component parts. Possible parts may for instance, for a table, include legs and panels. Each part is assigned a set of available characteristics. Possible characteristics may for instance, for table legs include, style, colour, material and finish. It is of course to be understood that these characteristics may vary according to the different types of items or furniture that are to be produced and/or sold.

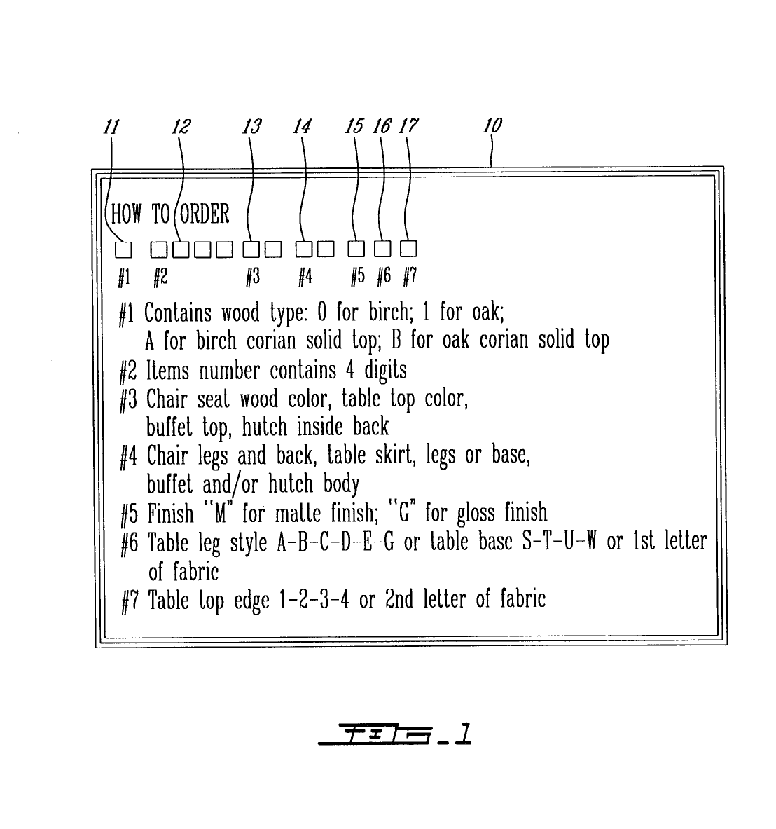

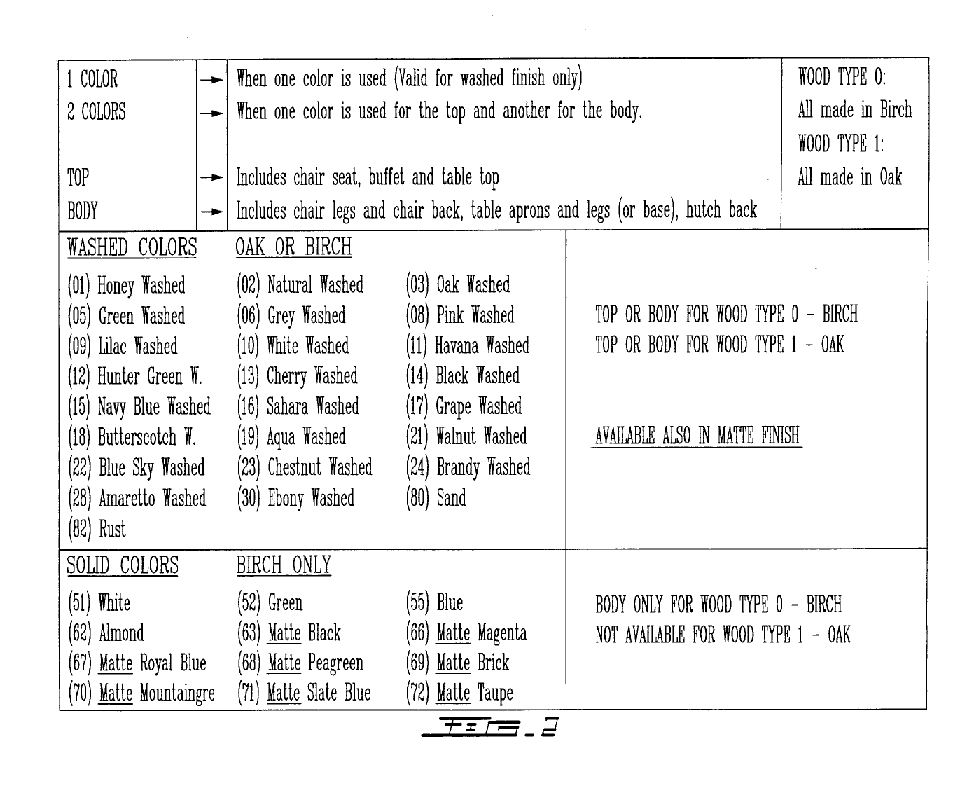

FIG. 1, shows an example page 10 of a catalogue according to one embodiment of the invention. The page 10 lists a possible set of characteristics of a product, and a partial listing of the different options available for each characteristic. In the embodiment shown in FIG. 1, said characteristics include wood type, item number, first colour, second colour, finish type, leg style, and edge style. The characteristics are preferably all given individual characteristic codes. The individual characteristic codes may be combined to make-up a unique product code which defines the product.

For instance, in FIG. 1, we can see that a product code may be made up of 7 identifiers. In this embodiment a first identifier 11 may be used to represent wood type.

A second identifier 12 may be a four digit item number representing the item type being ordered. For example, a table, a chair, etc. . .

A third identifier 13 may be a two digit code used to represent a first colour of a predetermined part of an item. For instance, in the case of a chair, the third identifier 13 could represent the colour of the seat, or in the case of a table the third identifier 13 could represent the colour of the top of the table.

A fourth identifier 14 may be used to represent a second colour of a predetermined part of an item. For instance, in the case of a chair, the fourth identifier 14, could represent the colour of the legs and the back, or in the case of a table the fourth identifier 14 could represent the colour of the legs.

A fifth identifier 15 may be a single letter, and may be used to represent the finish on the table. For instance, “M” for matte finish, and “G” for gloss finish.

A sixth identifier 16 may be a single letter, and may be used to represent the style of legs for a table or to represent a fabric type for a chair.

A seventh identifier 17 may be a single digit or letter, and may be used to represent the style of the table top edge, or to represent a fabric type for a chair.

When ordering, a customer using the system in its current embodiment, would actually generate a unique product code by selecting the type of item he or she would like to order (e.g a table, a chair, etc.). He or she would then select the value of each characteristic of the part(s) of the item, during the ordering process. After an order form has been filled out or generated, the customer can easily verify his or her order by simply looking at the product codes for the various items.

Additionally, the retailer can also put together each order easily by just looking at the product code, and not needing to correlate the product code to a master list items numbers or codes.

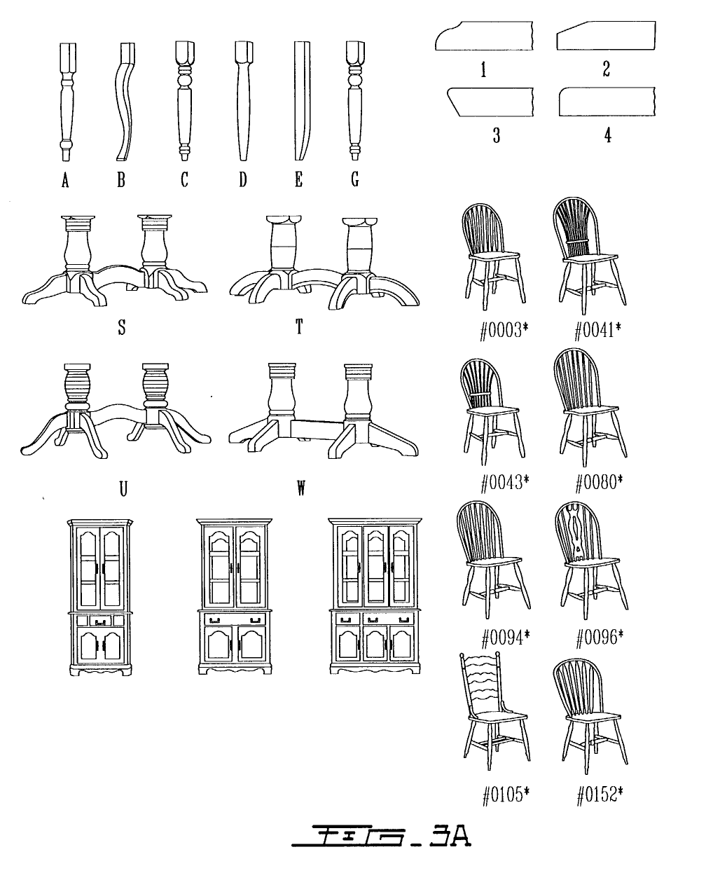

Turning to FIG. 2, we can see an second example page 20 of a catalogue, this page showing an example listing of the various predetermined values of the characteristics. In this case we see available wood types, and available colours for the various parts of a product.

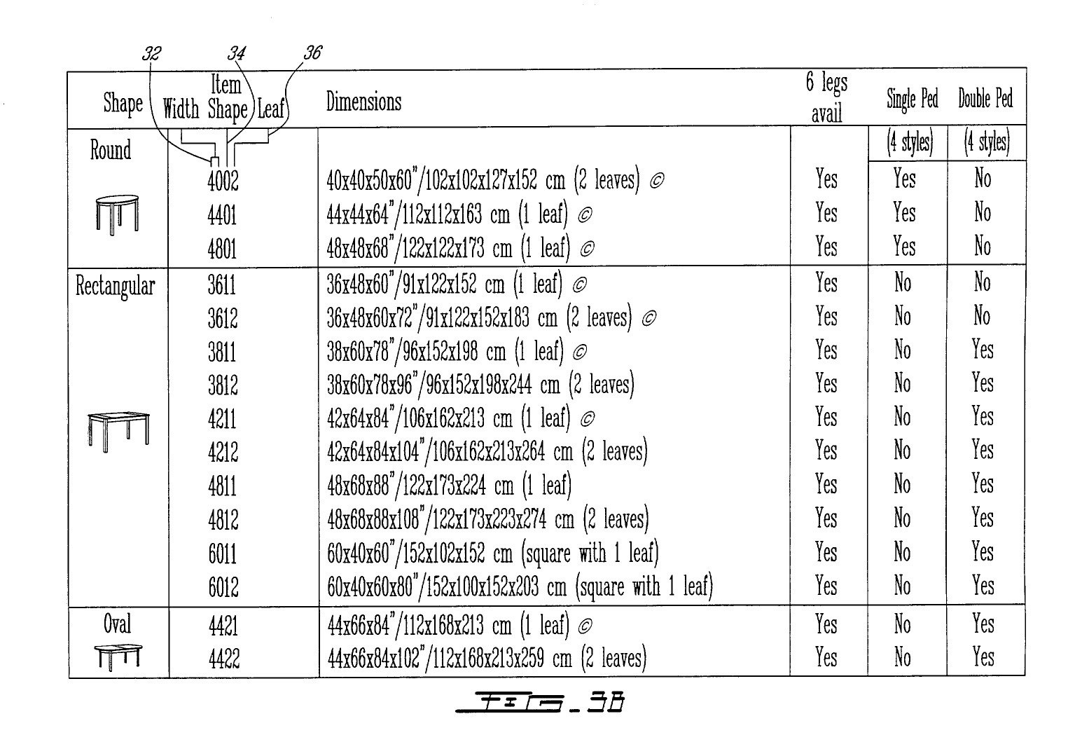

FIG. 3 shows a third example page 30 of a catalogue, this page showing an example listing of item codes including leg and base types. The item code may be assigned to each table and chair with no correlation to the shape and size of the table or chair. The item code may also preferably, as shown in FIG. 3, be correlated to the shape and size of a table. For instance the first two digits 32 of a four digit item code may be used to signify the width of a table in inches, the third digit 34 the shape of a table (e.g. round, rectangular, oval, etc.), and the fourth digit the number of extension panels desired. It is also possible according to the system to have certain item numbers be assigned with correlation to shape and size (e.g tables) and others to be assigned with no correlation (e.g. chairs).

While the invention has been described in relation to several embodiments it will be apparent to those skilled in the art that several modifications and variations not mentioned exists. Accordingly the previous descriptions are only meant for the purposes of illustration, and are not meant to limit the scope of the invention.

1. A method of identifying items each having a plurality of component parts, each part having a set of characteristics, each said characteristic being selectable from a plurality of predetermined values, said method comprising the steps of:
a) assigning an identifier to each value of each characteristic each part,
b) creating a code for each part formed by the juxtaposition of the identifiers of each characteristic of such part,
c) creating a code for each item formed by the juxtaposition of the part codes applicable to such item,
d) providing a catalogue having a listing all of said possible item codes.

2. A method as claimed in claim 1, wherein said characteristics comprise material type and a first colour.

3. A method as claimed in claim 1, wherein said characteristics comprise a second colour and a coating type.

4. A method as claimed in claim 2 wherein said characteristics comprise a second colour and a coating type.

5. A method as claimed in claim 1, wherein said items are pieces of furniture.

6. A method as claimed in claim 5, wherein said prices of furniture are tables, chairs or butches.

7. A method as claimed in claim 4, wherein said items are pieces of furniture.

8. A method as claim in claim 7, wherein said prices of furniture are tables, chairs or butches.

9. A method for producing greater reliability in the selection of items each item having a plurality of component parts by selecting for each part, a set of predetermined individual characteristics, each characteristic having a plurality predetermined of values said method comprising the steps of:
a) assigning an identifier to each said value of each said individual characteristic of each said part,
b) creating a part code by juxtaposition of the identifiers of the values fo the selected characteristics such that no two part has the same identifier;
c) providing a catalogue having a listing all of said sets of individual characteristic, and
d) creating item code by selecting for each part of said item the desired characteristics using said identifiers, such that when ordering said item a customer can verify that the item that has been selected is the right one by looking at the product code.
